(19) United States
(12) Patent Application Publication
(10) Pub. No.: US 2026/0031449 A1
(43) Pub. Date: Jan. 29, 2026

(54) CAP ASSEMBLY AND SECONDARY BATTERY INCLUDING SAME

(71) Applicant: SAMSUNG SDI CO., LTD., Yongin-si (KR)

(72) Inventors: Seeun PARK, Yongin-si (KR); Misol KIM, Yongin-si (KR)

(21) Appl. No.: 18/951,906

(22) Filed: Nov. 19, 2024

(30) Foreign Application Priority Data
Jul. 23, 2024 (KR) 10-2024-0097275

(51) Int. Cl. H01M 50/176; H01M 50/15; H01M 50/342; H01M 50/533; H01M 50/536; H01M 50/55; H01M 50/566

(52) U.S. Cl. CPC H01M 50/176; H01M 50/15; H01M 50/3425; H01M 50/533; H01M 50/536; H01M 50/55; H01M 50/566; H01M 2200/20

(57) ABSTRACT

A cap assembly includes a cap plate that is coupled to a case, the case having an open upper end, the cap plate including a first vent hole, a first terminal and a second terminal electrically connected to an electrode assembly accommodated in the case and protruding from an upper surface of the cap plate, and an insulating plate below the cap plate, the insulating plate including a second vent hole positioned to correspond to the first vent hole, wherein each of the cap plate and the insulating plate includes terminal through-holes through which the first terminal and the second terminal are connected to electrode plate tabs on the electrode assembly.

### CROSS-REFERENCE TO RELATED APPLICATION

This application claims priority under 35 U.S.C. § 119 to Korean Patent Application No. 10-2024-0097275, filed in the Korean Intellectual Property Office on Jul. 23, 2024, the entire contents of which are hereby incorporated by reference.

### BACKGROUND

### 1. Field

Embodiments relate to a cap assembly and a secondary battery including the same.

### 2. Description of Related Art

A secondary battery is a rechargeable battery that can undergo multiple charge and discharge cycles. Such secondary batteries are mainly used in a wide range of applications, including electronic devices (such as smartphones, laptops, and tablets), electric vehicles, solar power systems, and emergency power supplies. In particular, lithium-ion batteries are widely utilized in various electronic devices and electric vehicles due to their high energy density and high charge-discharge efficiency.

Secondary batteries can be classified into cylindrical, prismatic, and pouch types based on the shape of the case. A prismatic secondary battery has a structure in which an electrode assembly is housed within a prismatic metal can. The electrode assembly is inserted into the prismatic metal can, and a cap plate is welded to the can to seal the can.

The above information disclosed in this Background section is for enhancement of understanding of the background of the present disclosure, and therefore, it may contain information that does not constitute related (or prior) art.

### SUMMARY

Embodiments include a cap assembly, including a cap plate that is coupled to a case, the case having an open upper end, the cap plate including a first vent hole, a first terminal and a second terminal electrically connected to an electrode assembly accommodated in the case and protruding from an upper surface of the cap plate, and an insulating plate below the cap plate and includes a second vent hole positioned to correspond to the first vent hole, wherein each of the cap plate and the insulating plate includes terminal through-holes through which the first terminal and the second terminal are connected to electrode plate tabs on the electrode assembly.

The terminal through-holes may include a first terminal through-hole through which the first terminal passes, and a second terminal through-hole through which the second terminal passes, and the cap assembly further includes insulating members to respectively secure the first terminal and the second terminal to the cap plate.

Each of the first terminal and the second terminal may have a thickness greater than that of the cap plate to penetrate through the cap plate.

The insulating members may each include a third through-hole on inner sides thereof through which the first terminal and the second terminal pass, respectively, and fixing portions on outer sides thereof that respectively secure the insulating members to the cap plate.

The first terminal may be connected to a first sub-plate on one of the electrode plate tabs, and the second terminal may be connected to a second sub-plate on another one of the electrode plate tabs.

The electrode plate tabs may include a first electrode plate tab and a second electrode plate tab, the first sub-plate may be connected to the first electrode plate tab, and the second sub-plate may be connected to the second electrode plate tab.

The first electrode plate tab may include two parts, and the second electrode plate tab may include two parts.

The first sub-plate and the first electrode plate tab may be welded together, and the second sub-plate and the second electrode plate tab may be welded together.

The first terminal, the first sub-plate, and the first electrode plate tab may be vertically arranged, and the second terminal, the second sub-plate, and the second electrode plate tab may be vertically arranged.

The first terminal and the first sub-plate may be welded together, and the second terminal and the second sub-plate may be welded together.

Embodiments include a secondary battery, including a first terminal and a second terminal electrically connected to an electrode assembly and protruding from an upper surface of a case, a first sub-plate connected to the first terminal, a second sub-plate connected to the second terminal, a cap plate arranged on upper surfaces of the first sub-plate and the second sub-plate, and an insulating plate arranged between the cap plate and each of the first sub-plate and the second sub-plate, wherein the first sub-plate is connected to the first terminal by the first terminal passing through the cap plate and the insulating plate, and the second sub-plate is connected to the second terminal by the second terminal passing through the cap plate and the insulating plate.

The cap plate may include terminal through-holes through which the first terminal and the second terminal are connected to electrode plate tabs disposed on the electrode assembly.

The terminal through-holes may include a first terminal through-hole through which the first terminal passes, and a second terminal through-hole through which the second terminal passes, and the secondary battery may further include insulating members to respectively secure the first terminal and the second terminal to the cap plate.

Each of the first terminal and the second terminal may have a thickness greater than that of the cap plate to penetrate through the cap plate.

The insulating members may each include third through-holes on inner sides thereof through which the first terminal and the second terminal pass, respectively, and fixing portions on outer sides thereof that respectively secure the insulating members to the cap plate.

The electrode plate tabs may include a first electrode plate tab and a second electrode plate tab, the first sub-plate may be connected to the first electrode plate tab, and the second sub-plate may be connected to the second electrode plate tab.

The first electrode plate tab may include one or more parts, and the second electrode tab may include one or more parts.

The first sub-plate and the first electrode plate tab may be welded together, and the second sub-plate and the second electrode plate tab may be welded together.

The first terminal and the first sub-plate may be welded together, and the second terminal and the second sub-plate may be welded together.

The first terminal, the first sub-plate, and the first electrode plate tab may be vertically arranged, and the second terminal, the second sub-plate, and the second electrode plate tab may be vertically arranged.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings.

Features will become apparent to those of skill in the art by describing in detail exemplary embodiments with reference to the attached drawings, in which:

FIG. 1 is a perspective view illustrating an example of a battery cell according to one or more embodiments of the present disclosure;

FIG. 2 is an exploded perspective view illustrating an example of a battery cell according to one or more embodiments of the present disclosure;

FIG. 3 is an exploded perspective view illustrating an example of a cap assembly according to one or more embodiments of the present disclosure;

FIGS. 4A and 4B each illustrate a terminal portion according one or more embodiments of the present disclosure;

FIG. 5 is a cross-sectional view illustrating a cap assembly assembled with terminals according to one or more embodiments of the present disclosure;

FIG. 6 is a cross-sectional view taken along A-A′ direction of the secondary battery shown in FIG. 1 according to one or more embodiments of the present disclosure; and

FIG. 7 is a cross-sectional view taken along the A-A′ direction of the secondary battery shown in FIG. 1 according to one or more other embodiments of the present disclosure.

### DETAILED DESCRIPTION

Features will become apparent to those of skill in the art by describing in detail exemplary embodiments with reference to the attached drawings in which:

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified. The terms used in this specification are intended to describe embodiments of the present disclosure and are not intended to limit the present disclosure.

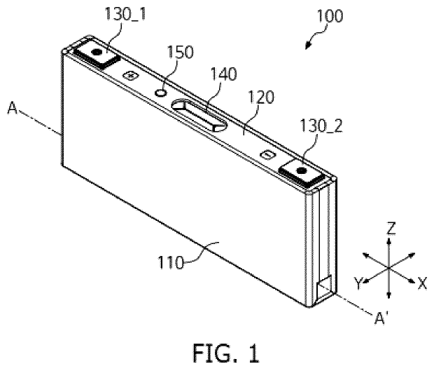

FIG. 1 is a perspective view illustrating an example of a battery cell 100 according to one or more embodiments of the present disclosure.

Referring to FIG. 1, the battery cell 100 may include at least one electrode assembly wound or stacked with a separator, which is an insulator, interposed between a positive electrode and a negative electrode; a case 110 accommodating the electrode assembly; and a cap plate 120 coupled to an open end of the case 110. The battery cell 100 shown in FIG. 1 may be a type of secondary battery.

Each of the positive electrode and the negative electrode may include a current collector made of a thin metal foil having a coated portion on which an active material is coated and an uncoated portion on which an active material is not coated. The positive electrode and the negative electrode are wound after interposing the separator, which is an insulator, therebetween. However, the present disclosure is not limited thereto, and the electrode assembly may have a structure in which a positive electrode and a negative electrode, each made of a plurality of sheets, are alternately stacked with a separator interposed therebetween.

The case 110 may form the overall outer appearance of the secondary battery and may be made of a conductive metal, such as aluminum, aluminum alloy, or nickel-plated steel. In addition, the case 110 may provide a space in which the electrode assembly is accommodated. In FIG. 1, the case 110 is a prismatic case, and the battery cell 100 is a prismatic battery cell. However, the scope of the present disclosure is not limited thereto. For example, the battery cell 100 may be, but not limited to, a prismatic battery cell, a cylindrical battery cell, a pouch-type battery cell, or the like.

The cap plate 120 may be coupled to the open end of the case 110 to seal the case 110. Each of the case 110 and the cap plate 120 may be made of a conductive material. In one embodiment, an upper end of the case 110 may be open, and the cap plate 120 may seal the open upper end of the case 110.

A positive electrode terminal 130_1 may be electrically connected to the positive electrode and a negative electrode terminal 130_2 may be electrically connected to the negative electrode may be coupled to the cap plate 120. For example, the positive and negative electrode terminals 130_1 and 130_2 may be installed to protrude outward through the cap plate 120.

In one embodiment, a vent 140 may be formed on at least one surface of the battery cell 100 (for example, on an upper surface of the battery cell 100, i.e., the cap plate 120, in the illustrated example). The vent 140 may be configured to open in an event that an internal pressure exceeding a predetermined threshold pressure is detected within the battery cell 100.

In this case, the threshold pressure may be set differently depending on the applications, materials, purpose, and other factors of the battery. For example, a relatively high threshold pressure may be set for a battery in which the internal pressure of the case 110 is maintained at a higher pressure on average compared to other applications due to short charge-discharge cycles during use. In another example, a relatively high threshold pressure may be set for a battery that is manufactured with materials and/or designs that have relatively high heat resistance and/or pressure resistance. In contrast, a relatively low threshold pressure may be set for a battery that is manufactured with materials and/or designs that have relatively low heat resistance and/or pressure resistance. Additionally or alternatively, the vent 140 may be configured to open in an event that an internal temperature exceeds a predetermined threshold temperature. With such a configuration, the vent 140 may prevent explosion of the battery cell 100 or may prevent a chain exothermic reaction of other battery cells arranged adjacent to the battery cell 100.

In one embodiment, the cap plate 120 may include an electrolyte injection port 150. For example, the electrolyte injection port 150 may be a through-hole provided in the cap plate 120, and may be formed such that the electrolyte is injected into the case 110 after the cap plate 120 is coupled and sealed to an opening of the case 110. The electrolyte injection port 150 may be sealed with a sealing member after the electrolyte is injected.

The battery cell 100 may be a lithium (Li) battery cell, a sodium (Na) battery cell, or the like. However, the scope of the present disclosure is not limited thereto, and the battery cell 100 may include any battery cell capable of repeatedly providing electricity by being charged and discharged. In one embodiment, in a case where the battery cell 100 is the Li battery cell, the battery cell 100 may be used in electric vehicles (EVs) due to its excellent lifespan and high-rate capability. For example, the battery cell 100 may be used in electric vehicles or hybrid vehicles such as plug-in hybrid electric vehicles (PHEVs). Additionally, the Li battery cell may be used in fields requiring a large amount of power storage. For example, the battery cell 100 may be used in electric bicycles, power tools, and similar applications.

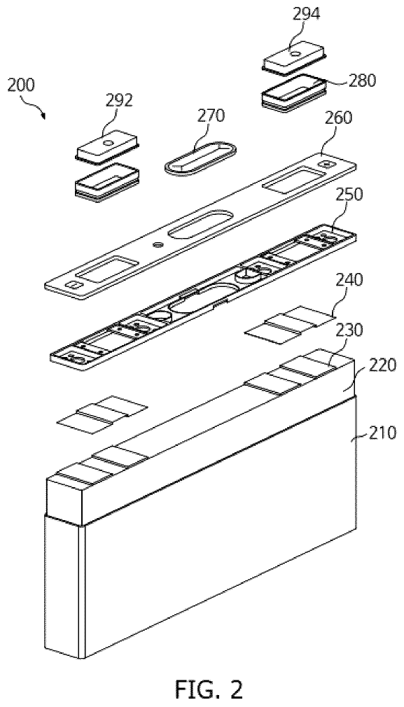

FIG. 2 is an exploded perspective view illustrating an example of a battery cell 200 according to one or more embodiments of the present disclosure.

Referring to FIG. 2, the battery cell 200 may include a case 210 that accommodates an electrode assembly 220 therein through an open upper end of the case 210. The electrode assembly 220 may be provided by winding or stacking a laminate including a first electrode plate (not shown), a separator (not shown), and a second electrode plate (not shown) each formed as a thin plate or film. In a case where the electrode assembly 220 is a wound laminate, the axis of the winding thereof may be parallel to the longitudinal direction of the case. In addition, the electrode assembly 220 may be a stack type instead of being a wound type, but the shape of the electrode assembly 220 of the present disclosure is not limited thereto. In addition, the electrode assembly 220 may be a Z stack electrode assembly in which a positive electrode plate and a negative electrode plate are provided on opposite sides of the separator bent as a Z stack. In addition, one or more electrode assemblies 220 may be stacked so that the long sides thereof are adjacent to each other so as to be received in the case. The present disclosure is not intended to limit the number of electrode assemblies 220. In the electrode assembly 220, the first electrode plate may act as a positive electrode, and the second electrode plate may act as a negative electrode. The reverse is also possible.

The first electrode plate may be formed by applying a first electrode active material, such as graphite or carbon, to a first electrode collector plate formed of a metal foil of, for example, copper (Cu), a Cu alloy, nickel (Ni), or a Ni alloy, and may include a first electrode tab (or a first uncoated portion) which is a region to which the first electrode active material is not applied. The first electrode tab may be a path for current flow between the first electrode plate and the first subplate assembly. In some examples, the first electrode tab may be formed by previously cutting the first electrode plate so that the first electrode tab protrudes from a first side in a case where the first electrode plate is fabricated, and may protrude further from the first side than the separator without additional cutting.

The second electrode plate is formed by applying a second electrode active material, such as a transition metal oxide, to a second electrode collector plate formed of a metal foil of, for example, Al or an Al alloy, and may include a second electrode tab (or a second uncoated portion) which is a region to which the second electrode active material is not applied. The second electrode tab may be a path for current flow between the second electrode plate and the second subplate assembly. In some examples, the second electrode tab may be formed by previously cutting the second electrode plate so that the second electrode tab protrudes from a second side in a case where the second electrode plate is fabricated, and may protrude further from the second side than the separator without additional cutting.

An electrode plate tab 230 may be configured to electrically connect the electrode tab of the electrode assembly 220 to the external electrode terminal. The electrode plate tab 230 may be formed in a region of the electrode tab where the active material is not applied. Herein, the electrode plate tabs may be referred to as singular and plural. Thus, the electrode plate tabs 230 may be coupled by assembling the electrode tabs at an upper region (in the orientation shown in FIG. 2) of the electrode assembly. The electrode plate tab 230 may include one or more parts.

The electrode plate tab 230 may be connected to a sub-plate 240. The sub-plate 240 may be configured to electrically connect the electrode plate tab 230 to the external electrode terminal. The sub-plate 240 may be configured to be connected to the electrode plate tab 230 including one or more parts to establish a connection with the electrode terminal.

An insulation plate 250 may be connected to an upper portion of the sub-plate 240. An upper portion of the insulation plate 250 may be connected to a cap plate 260. The insulation plate 250 may be provided in a size approximately corresponding to the size of the cap plate 260. In one embodiment, the insulation plate 250 may be a substantially rectangular flat plate. The insulation plate 250 may be in close contact with a lower surface of the cap plate 260 and may be spaced apart from the electrode assembly by a predetermined distance. The insulation plate 250 and the cap plate 260 may include vent holes corresponding to (e.g., aligned with) the vent. In one embodiment, the cap plate 260 may seal the opening of the case and may be made of the same material as the case. The cap plate 260 may be coupled to the case by welding.

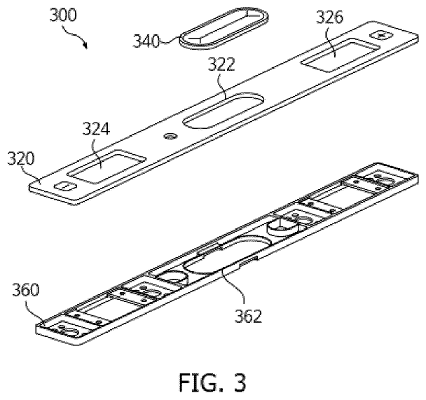

The cap plate 260 may include a terminal through-hole. The terminal through-hole formed at the cap plate 260 may be configured to connect the electrode terminal to the electrode plate tab 230. The terminal through-hole may allow the electrode terminal to pass through the cap plate 260 toward the case 210 and connect with the sub-plate 240. The structure of the terminal through-hole in the cap plate 260 will be described in detail later with reference to FIG. 3.

A vent 270 may be formed on at least one surface of the battery cell 200 (for example, on an upper surface of the battery cell 200, i.e., the cap plate 260, in the illustrated example). The vent 270 may be configured to open in the event that an internal pressure exceeds a predetermined threshold pressure is detected in the battery cell 200. The vent 270 may include a notch to allow the vent 270 to open at a predetermined pressure.

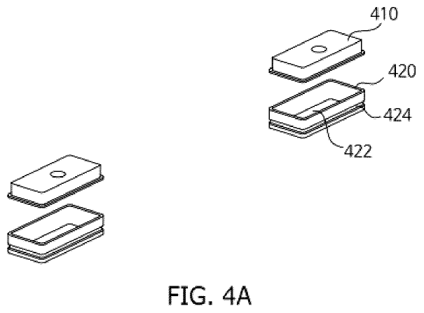

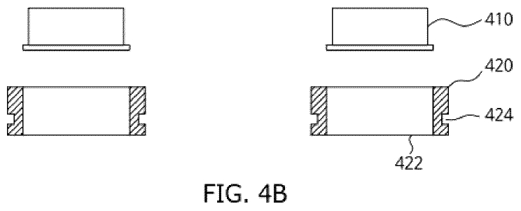

An insulating member 280 may be configured to secure and insulate the electrode terminal in the terminal through-hole of the cap plate 260. An inner surface of the insulating member 280 may be configured to be perforated to receive the electrode terminal. The structure of the insulating member 280 will be described in detail later with reference to FIG. 4.

The electrode terminals 292 and 294 may include a positive electrode terminal electrically connected to the positive electrode and a negative electrode terminal electrically connected to the negative electrode. The electrode terminals 292 and 294 may be coupled to the cap plate 260. The electrode terminals 292 and 294 may be installed to protrude outward from the case 210 through the cap plate 260. The electrode terminals 292 and 294 may also extend through the cap plate 260 in the direction toward the inside of the case 210. In order to penetrate through the cap plate 260, each of the electrode terminals 292 and 294 may have a thickness greater than that of the cap plate 260.

In one embodiment, each of the electrode terminals 292 and 294, which extend in the direction toward the inside of the case 210, may be connected to the sub-plate 240. Each of the electrode terminals 292 and 294 may be joined to the sub-plates 240 by welding. The sub-plate 240 and the electrode plate tab 230 may also be connected, and the electrode plate tab 230 and the sub-plate 240 may be joined by welding.

FIG. 3 is an exploded perspective view illustrating an example of a cap assembly according to one or more embodiments of the present disclosure.

A cap assembly 300 may include a cap plate 320, a vent 340, and an insulation plate 360. The cap assembly 300 may be coupled to the case. In one embodiment, the cap plate 320 may seal the opening of the case and may be made of the same material as the case. The cap plate 320 may be coupled to the case by, for example, welding. The cap plate 320 may include a first vent hole 322. The vent 340 may be installed in the first vent hole 322 of the cap plate 320. The vent 340 may include a notch to allow the vent 340 to open at a predetermined pressure.

The cap plate 320 may include terminal through-holes 324 and 326 at positions where the electrode terminals are arranged. The terminal through-holes 324 and 326 may be configured to connect the electrode terminals to the sub-plates. The terminal through-holes 324 and 326 may form passage holes in the cap plate 320 to allow the electrode terminals to pass therethrough. The terminal through-holes may include a first terminal through-hole 324 and a second terminal through-hole 326.

The insulation plate 360 may be provided in a size corresponding to (e.g., equal to) the size of the cap plate 320. The insulation plate 360 may be positioned below the cap plate 320 (in the orientation shown). The insulation plate 360 may include a second vent hole 362. The second vent hole 362 of the insulation plate 360 may be formed at a position corresponding to (e.g., aligned with or overlapping) the first vent hole 322 of the cap plate 320.

FIGS. 4A and 4B each illustrate a terminal portion according one or more embodiments of the present disclosure.

FIG. 4A is an exploded perspective view of the terminal portion. The terminal portion may include electrode terminals 410 and insulating members 420. The electrode terminals 410 may include a positive electrode terminal electrically connected to the positive electrode and a negative electrode terminal electrically connected to the negative electrode. The electrode terminals 410 may be coupled to the cap plate. For example, the electrode terminals 410 may be installed such that the electrode terminals pass through the cap plate and protrude outward from the cap plate. The electrode terminals 410 may extend through the cap plate in the direction toward the inside of the case. The electrode terminals 410 may pass through the cap plate to connect with the sub-plates, respectively, and the electrode terminals 410 and the sub-plates may be joined by welding. In order to penetrate through the cap plate, each of the electrode terminals 410 may have a thickness greater than that of the cap plate.

The insulating members 420 may be configured to secure and insulate the electrode terminals 410 within the terminal through-holes of the cap plate, respectively. An inner surface of each of the insulating members 420 may include a third through-hole 422 to receive the corresponding electrode terminal. The third through-hole 422 of each of the insulating members 420 may be provided in a size corresponding to the size of the corresponding electrode terminal 410. A thickness of each of the insulating members 420 may be similar to or smaller than that of the corresponding electrode terminal 410.

The insulating members 420 may respectively include fixing portions 424 on outer sides thereof. The fixing portions 424 may be respectively configured to secure the insulating members 420 to the cap plate. Each fixing portion 424 may be formed as a recessed groove on the outer side of the corresponding insulating member 420. Each of the insulating members 420 may be fitted to the cap plate by the corresponding fixing portion 424. Each of the fixing portions 424 may be formed to have a height equal to the thickness of the cap plate.

FIG. 4B shows a cross-sectional view of the disassembled terminal portion of FIG. 4A. Each electrode terminal 410 may pass through the cap plate and connect with the sub-plate. The electrode terminal 410 may have a thickness greater than that of the cap plate in order to penetrate through the cap plate. The electrode terminal 410 may be fitted into the insulating member 420. The inner surface of the insulating member 420 may include the third through-hole 422 to accommodate the electrode terminal. The third through-hole 422 of the insulating member 420 may be provided in a size corresponding to that of the electrode terminal 410. The thickness of the insulating member 420 may be similar to or smaller than that of the electrode terminal 410.

Each insulating member 420 may include a fixing portion 424 on the outer side thereof. The fixing portion 424 may be configured to secure the insulating member 420 to the cap plate. The fixing portion 424 may be formed as a recessed groove on the outer side of the insulating member 420. The insulating member 420 may be fitted into the cap plate by the fixing portion 424. The fixing portion 424 may be formed to have a height equal to the thickness of the cap plate.

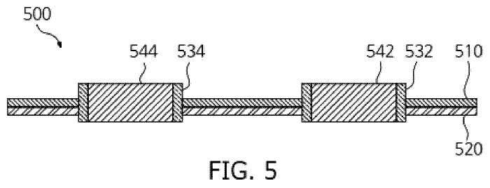

FIG. 5 is a cross-sectional view illustrating a cap assembly assembled with terminals according to one or more embodiments of the present disclosure.

A cap assembly 500 may include a cap plate 510 and an insulating plate 520. The cap assembly 500 may be coupled to the case. In one embodiment, the cap plate 510 may seal the opening of the case and may be made of the same material as the case. The insulating plate 520 may be provided in a size corresponding to that of the cap plate 510. The insulating plate 520 may be disposed below the cap plate 510 in the orientation shown.

Electrode terminals 542 and 544, along with insulating members 532 and 534, may be fitted into terminal through-holes of the cap plate 510, respectively. The electrode terminals 542 and 544 may protrude outward through the cap plate 510. Further, the electrode terminals 542 and 544 may extend through the cap plate 510 in a direction toward the inside of the case. Each of the electrode terminals 542 and 544 may have a thickness greater than that of the cap plate 510 in order to penetrate through the cap plate.

The electrode terminals 542 and 544 may be coupled with the insulating members 532 and 534, respectively. The insulating members 532 and 534 may be respectively configured to secure and insulate the electrode terminals 542 and 544 relative to the cap plate 510. The first electrode terminal 542 may be fixed in a first through-hole of the cap plate 510 by being coupled with the first insulating member 532. Similarly, the second electrode terminal 544 may be fixed in a second through-hole of the cap plate 510 by being coupled with the second insulating member 534.

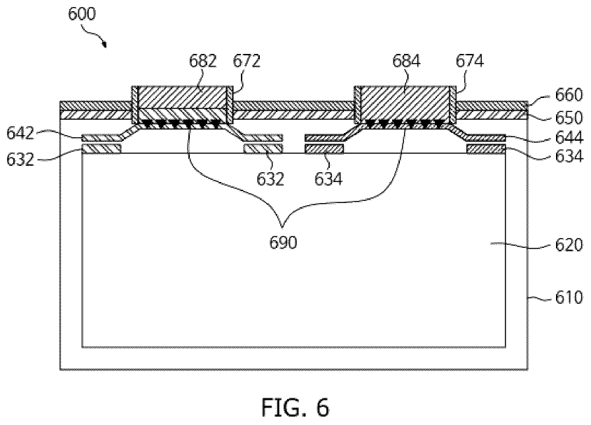

FIG. 6 is a cross-sectional view taken along the A-A′ direction of the secondary battery shown in FIG. 1 according to one embodiment of the present disclosure.

A secondary battery 600 may include at least one electrode assembly 620, each of which is wound or stacked with a separator, which is an insulator, interposed between a positive electrode plate and a negative electrode plate, a case 610 accommodating the electrode assembly 620, and a cap assembly coupled to an opening of the case 610.

The secondary battery according to the present embodiment is described as an example of a prismatic lithium-ion secondary battery. However, the scope of the present disclosure is not limited thereto, and the embodiment of the present disclosure may be applicable to various types of batteries, including lithium polymer batteries or cylindrical batteries.

The positive and negative electrode plates may respectively include current collectors each made of a thin metal foil. The current collector of the positive electrode plate may include a coated portion onto which an active material is applied and a positive uncoated portion onto which the active material is not applied. The current collector of the negative electrode plate may include a coated portion onto which an active material is applied and a negative uncoated portion onto which the active material is not applied.

The positive and negative electrode plates may be wound with the separator, which serves as the insulator, interposed therebetween. However, the scope of the present disclosure is not limited thereto, and the electrode assembly described above may have a structure in which a plurality of sheets of positive and negative electrodes are alternately stacked with separators interposed between them.

The case 610 may form the overall outer appearance of the secondary battery and may be made of a conductive metal, such as aluminum, an aluminum alloy, or a nickel-plated steel. In addition, the case 610 may provide a space to accommodate the electrode assembly 620.

The electrode plate tabs 632 and 634 may be configured to electrically connect the electrode tabs of the electrode assembly 620 to external electrode terminals. The electrode plate tabs 632 and 634 may be formed in regions of the electrode tabs on each of which the active material is not coated. The electrode plate tabs 632 and 634 may be coupled by assembling the electrode tabs at the upper portion of the electrode assembly in the orientation shown. For example, referring to FIG. 6, a first electrode plate tab 632 may represent the positive electrode (or the negative electrode). The first electrode plate tabs 632 may be coupled by assembling the positive electrode plates (or the negative electrode plates). The first electrode plate tab 632 may include two parts. Two parts of the first electrode plate tab 632 may be coupled to a first sub-plate 642. The first electrode plate tab 632 and the first sub-plate 642 may be coupled by welding. A second electrode plate tab 634 may represent the negative electrode (or the positive electrode). The second electrode plate tabs 634 may be coupled by assembling the negative electrode plates (or the positive electrode plates). The second electrode plate tab 634 may include two parts. The two parts of the second electrode plate tab 634 may be coupled to a second sub-plate 644. The second electrode plate tab 634 and the second sub-plate 644 may be coupled by welding.

The cap assembly may include a cap plate 660 that covers the opening of the case 610. Both the case 610 and the cap plate 660 may be made of conductive materials. Here, the positive and negative electrode terminals 682 and 684, which are electrically connected to the positive or negative electrode plates, may be installed to protrude outward through the cap plate 660.

The insulating plate 650 may be provided in a size corresponding to that of the cap plate 660. The insulating plate 650 may be disposed below the cap plate 660 (e.g., between the cap plate 660 and the first and second sub-plates, 642 and 644, respectively).

The electrode terminals 682 and 684 and insulating members 672 and 674 may be fitted into terminal through-holes of the cap plate 660, respectively. The electrode terminals 682 and 684 may be installed to protrude outward (e.g., toward the outside of the secondary battery 600) through the cap plate 660 and may also extend through the cap plate 660 in the direction toward the inside of the case. Each of the electrode terminals 682 and 684 may have a thickness greater than that of the cap plate 660 to penetrate through the cap plate 660.

The electrode terminals 682 and 684 may be coupled with the insulating members 672 and 674, respectively. The insulating members 672 and 674 may be respectively designed to secure and insulate the electrode terminals 682 and 684 relative to the cap plate 660. The first electrode terminal 682 may be coupled with the first insulating member 672, and the first electrode terminal 682 coupled with the first insulating member 672 may be fixed in the first through-hole of the cap plate 660. Similarly, the second electrode terminal 684 may be coupled with the second insulating member 674, and the second electrode terminal 684 coupled with the second insulating member 674 may be fixed in the second through-hole of the cap plate 660.

The electrode terminals 682 and 684 that penetrate through the cap plate 660 may be respectively connected to the sub-plates 642 and 644. The first electrode terminal 682 may be connected to the first sub-plate 642, and this connection between the first electrode terminal 682 and the first sub-plate 642 may be established by welding 690. Consequently, the first electrode terminal 682, the first sub-plate 642, and the first electrode plate tab 632 may be arranged in the vertical direction. Similarly, the second electrode terminal 684 may be connected to the second sub-plate 644, and this connection between the second electrode terminal 684 and the second sub-plate 644 may also be established by welding 690. Consequently, the second electrode terminal 684, the second sub-plate 644, and the second electrode plate tab 634 may be arranged in the vertical direction.

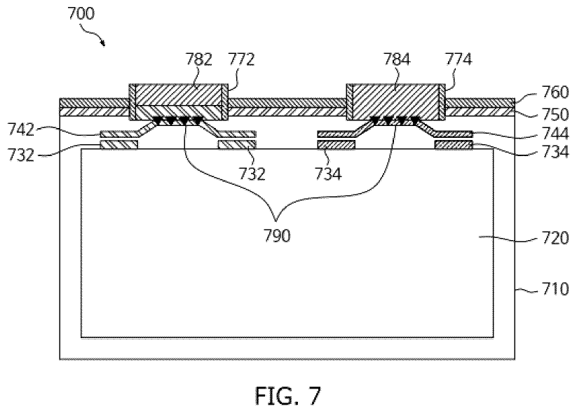

FIG. 7 is a cross-sectional view taken along the A-A′ direction of the secondary battery shown in FIG. 1 according to one or more other embodiments of the present disclosure.

A secondary battery 700 may include at least one electrode assembly 720, each of which is wound or stacked with a separator, which is an insulator, interposed between a positive electrode plate and a negative electrode plate, a case 710 accommodating the electrode assembly 720, and a cap assembly coupled to an opening of the case 710.

The electrode plate tabs 732 and 734 may be configured to electrically connect the electrode tabs of the electrode assembly 720 to external electrode terminals. The electrode plate tabs 732 and 734 may be formed in regions of the electrode tabs on each of which the active material is not coated. The electrode plate tabs 732 and 734 may be coupled by assembling the electrode tabs at the upper portion of the electrode assembly in the orientation shown. For example, referring to FIG. 7, a first electrode plate tab 732 may represent the positive electrode (or the negative electrode). The first electrode plate tabs 732 may be coupled by assembling the positive electrode plates (or the negative electrode plates). The first electrode plate tab 732 may be coupled to a first sub-plate 742. The first electrode plate tab 732 and the first sub-plate 742 may be coupled by welding. A second electrode plate tab 734 may represent the negative electrode (or the positive electrode). The second electrode plate tabs 734 may be coupled by assembling the negative electrode plates (or the positive electrode plates). The second electrode plate tab 734 may be coupled to a second sub-plate 744. The second electrode plate tab 734 and the second sub-plate 744 may be coupled by welding.

The cap assembly may include a cap plate 760 that covers the opening of the case 710. Both the case 710 and the cap plate 760 may be made of conductive materials. Here, the positive and negative electrode terminals 782 and 784, which are electrically connected to the positive or negative electrode plates, may be installed to protrude outward through the cap plate 760.

The insulating plate 750 may be provided in a size corresponding to that of the cap plate 760. The insulating plate 750 may be disposed below the cap plate 760 (e.g., between the cap plate 760 and the first sub-plate 742 and the second sub-plate 744).

The electrode terminals 782 and 784 and insulating members 772 and 774 may be fitted into terminal through-holes of the cap plate 760, respectively. The electrode terminals 782 and 784 may be installed to protrude outward (toward the outside) through the cap plate 760 and may also extend through the cap plate 760 in the direction toward the inside of the case. Each of the electrode terminals 782 and 784 may have a thickness greater than that of the cap plate 760 to penetrate through the cap plate 760.

The electrode terminals 782 and 784 may be coupled with the insulating members 772 and 774, respectively. The insulating members 772 and 774 may be respectively designed to secure and insulate the electrode terminals 782 and 784 relative to the cap plate 760. The first electrode terminal 782 may be coupled with the first insulating member 772, and the first electrode terminal 782 coupled with the first insulating member 772 may be fixed in the first through-hole of the cap plate 760. Similarly, the second electrode terminal 784 may be coupled with the second insulating member 774, and the second electrode terminal 784 coupled with the second insulating member 774 may be fixed in the second through-hole of the cap plate 760.

The electrode terminals 782 and 784 that penetrate through the cap plate 760 may be connected to the sub-plates 742 and 744, respectively. The first electrode terminal 782 may be connected to the first sub-plate 742, and this connection between the first electrode terminal 782 and the first sub-plate 742 may be established by welding 790. Consequently, the first electrode terminal 782, the first sub-plate 742, and the first electrode plate tab 732 may be vertically arranged in the orientation shown. Similarly, the second electrode terminal 784 may be connected to the second sub-plate 744, and this connection between the second electrode terminal 784 and the second sub-plate 744 may also be established by welding 790. Consequently, the second electrode terminal 784, the second sub-plate 744, and the second electrode plate tab 734 may be vertically arranged in the orientation shown.

In a case where each of the electrode plate tabs 732 and 734 is composed of a single part for each electrode terminal, the sub-plates 742 and 744 may not be necessary, depending on the requirement. That is, the electrode plate tabs 732 and 734 may be directly connected and welded to the electrode terminals 782 and 784, respectively.

According to one or more embodiments of the present disclosure, by arranging the terminals to pass through the cap plate and connecting the terminals to the sub-plates, resistance can be reduced by shortening the current path.

According to one or more embodiments of the present disclosure, by eliminating the current collector and connecting the terminals directly to the sub-plates, the number of battery components can be reduced, leading to lower costs and increased manufacturing process efficiency.

According to one or more embodiments of the present disclosure, the coating area of the electrode plates can be increased, thereby enhancing the battery capacity.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A cap assembly, comprising:
a cap plate that is coupled to a case, the case having an open upper end, the cap plate comprising a first vent hole;
a first terminal and a second terminal electrically connected to an electrode assembly accommodated in the case and protruding from an upper surface of the cap plate; and
an insulating plate below the cap plate, the insulating plate comprising a second vent hole positioned to correspond to the first vent hole,
wherein each of the cap plate and the insulating plate comprises terminal through-holes through which the first terminal and the second terminal are connected to electrode plate tabs on the electrode assembly.

2. The cap assembly as claimed in claim 1, wherein:
the terminal through-holes comprise:
a first terminal through-hole through which the first terminal passes; and
a second terminal through-hole through which the second terminal passes, and
the cap assembly further comprises insulating members to respectively secure the first terminal and the second terminal to the cap plate.

3. The cap assembly as claimed in claim 2, wherein each of the first terminal and the second terminal has a thickness greater than that of the cap plate to penetrate through the cap plate.

4. The cap assembly as claimed in claim 2, wherein the insulating members each comprise:
a third through-hole on inner sides thereof through which the first terminal and the second terminal pass, respectively; and
fixing portions on outer sides thereof that respectively secure the insulating members to the cap plate.

5. The cap assembly as claimed in claim 1, wherein the first terminal is connected to a first sub-plate on one of the electrode plate tabs, and the second terminal is connected to a second sub-plate on another one of the electrode plate tabs.

6. The cap assembly as claimed in claim 5, wherein the electrode plate tabs comprise a first electrode plate tab and a second electrode plate tab, and
the first sub-plate is connected to the first electrode plate tab, and the second sub-plate is connected to the second electrode plate tab.

7. The cap assembly as claimed in claim 6, wherein the first electrode plate tab includes two parts, and the second electrode plate tab includes two parts.

8. The cap assembly as claimed in claim 6, wherein the first sub-plate and the first electrode plate tab are welded together, and the second sub-plate and the second electrode plate tab are welded together.

9. The cap assembly as claimed in claim 6, wherein the first terminal, the first sub-plate, and the first electrode plate tab are vertically arranged, and
the second terminal, the second sub-plate, and the second electrode plate tab are vertically arranged.

10. The cap assembly as claimed in claim 5, wherein the first terminal and the first sub-plate are welded together, and the second terminal and the second sub-plate are welded together.

11. A secondary battery, comprising:
a first terminal and a second terminal electrically connected to an electrode assembly and protruding from an upper surface of a case;
a first sub-plate connected to the first terminal;
a second sub-plate connected to the second terminal;
a cap plate arranged on upper surfaces of the first sub-plate and the second sub-plate; and
an insulating plate arranged between the cap plate and each of the first sub-plate and the second sub-plate,
wherein the first sub-plate is connected to the first terminal by the first terminal passing through the cap plate and the insulating plate, and
the second sub-plate is connected to the second terminal by the second terminal passing through the cap plate and the insulating plate.

12. The secondary battery as claimed in claim 11, wherein the cap plate comprises terminal through-holes through which the first terminal and the second terminal are connected to electrode plate tabs disposed on the electrode assembly.

13. The secondary battery as claimed in claim 12, wherein:
the terminal through-holes comprise:
a first terminal through-hole through which the first terminal passes, and
a second terminal through-hole through which the second terminal passes, and
the secondary battery further comprises insulating members to respectively secure the first terminal and the second terminal to the cap plate.

14. The secondary battery as claimed in claim 12, wherein each of the first terminal and the second terminal has a thickness greater than that of the cap plate to penetrate through the cap plate.

15. The secondary battery as claimed in claim 13, wherein the insulating members each comprise:
third through-holes on inner sides thereof through which the first terminal and the second terminal pass, respectively, and
fixing portions on outer sides thereof that respectively secure the insulating members to the cap plate.

16. The secondary battery as claimed in claim 12, wherein the electrode plate tabs comprise a first electrode plate tab and a second electrode plate tab, the first sub-plate is connected to the first electrode plate tab, and the second sub-plate is connected to the second electrode plate tab.

17. The secondary battery as claimed in claim 16, wherein the first electrode plate tab includes one or more parts, and the second electrode plate tab includes one or more parts.

18. The secondary battery as claimed in claim 16, wherein the first sub-plate and the first electrode plate tab are welded together, and the second sub-plate and the second electrode plate tab are welded together.

19. The secondary battery as claimed in claim 11, wherein the first terminal and the first sub-plate are welded together, and the second terminal and the second sub-plate are welded together.

20. The secondary battery as claimed in claim 16, wherein the first terminal, the first sub-plate, and the first electrode plate tab are vertically arranged, and
the second terminal, the second sub-plate, and the second electrode plate tab are vertically arranged.
